(19) United States
(12) Patent Application Publication
(10) Pub. No.: US 2006/0268190 A1
(43) Pub. Date: Nov. 30, 2006

(54) Liquid crystal display device having light shielding sheet

(75) Inventors: Chih-Chia Yu, Miao-Li (TW); Cheng-Fang Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/442,766

(22) Filed: May 30, 2006

(30) Foreign Application Priority Data
May 27, 2005 (TW) 94208716

(51) Int. Cl. G02F 1/1333

(52) U.S. Cl. 349/58

(57) ABSTRACT

An exemplary liquid crystal display device (1) includes a liquid crystal panel (11) and a backlight module (12) disposed adjacent to the liquid crystal panel. The backlight module includes a frame (18) having a plurality of holes (182), an optical sheet (14) disposed in the frame, and a light shielding sheet (13) disposed between the liquid crystal panel and the optical sheet. The light shielding sheet is frame-shaped, and includes a plurality of outer walls (134) having a plurality of protrusions (136) formed on the outer walls. The protrusions are respectively corresponding to the holes of the frame, and each of the protrusions extends in a direction away from a center of the light shielding sheet. The liquid crystal display device is convenient for disassembly and can avoid a waving phenomena caused by an adhesive used in a conventional liquid crystal display device.

### FIELD OF THE INVENTION

The present invention relates to liquid crystal display devices (LCDs), and more particularly to a liquid crystal display device having a light shielding sheet.

### GENERAL BACKGROUND

Liquid crystal displays are commonly used as display devices for compact electronic apparatuses, because they not only provide good quality images with little power but are also very thin.

A light shielding sheet is generally used in a liquid crystal display device to prevent light beams from leaking out of the display device. The light shielding sheet is generally in the form of a rectangular frame that includes an adhesive thereon. In use, the light shielding sheet is adhesively covered on edges of an optical sheet and a plastic frame that accommodates the optical sheet.

However, the assembly comprising the light shielding sheet, the optical sheet and the plastic frame may need to be disassembled; for example, in order to replace the optical sheet with a new one. In disassembly, it is difficult to release the light shielding sheet from the optical sheet and the plastic frame because of the strength of the adhesive bond of the light shielding sheet. Thus the optical sheet and the plastic frame are liable to be damaged. Furthermore, in mass production of the liquid crystal display device, it is commonplace for each assembled liquid crystal display device to be tested for stability and heat endurance and resistance. The liquid crystal display device may be maintained at a temperature of 40˜50° C. during such testing. The adhesive of the light shielding sheet may bend when subjected to high temperatures, which can result in a so-called waving phenomena of the light shielding sheet occurring. When this happens, if the light shielding sheet is not replaced, the optical performance of the liquid crystal display device may be diminished. One the other hand, if the light shielding sheet is replaced, this is problematic as described above.

What is needed, therefore, is a liquid crystal display device that can overcome the above-described deficiencies.

### SUMMARY

A liquid crystal display device includes a liquid crystal panel, and a backlight module disposed adjacent to the liquid crystal panel. The backlight module includes a frame having a plurality of holes, an optical sheet disposed in the frame, and a frame-shaped light shielding sheet disposed between the liquid crystal panel and the optical sheet. The light shielding sheet includes a plurality of outer walls having a plurality of protrusions formed on the outer walls. The protrusions are respectively corresponding to the holes of the frame, and each of the protrusions extends in a direction away from a center of the light shielding sheet.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of a liquid crystal display device according to a first embodiment of the present invention.

FIG. 2 is an isometric view of a light shielding sheet of the liquid crystal display device of FIG. 1.

FIG. 3 is an enlarged, cross-sectional view showing a protrusion of the light shielding sheet engaging in a hole of a frame of the liquid crystal display device of FIG. 1.

FIG. 4 is an isometric view of a light shielding sheet of a liquid crystal display device according to a second embodiment of the present invention.

FIG. 5 is an isometric view of a light shielding sheet of a liquid crystal display device according to a third embodiment of the present invention.

FIG. 6 is an isometric view of a light shielding sheet of a liquid crystal display device according to a fourth embodiment of the present invention.

FIG. 7 is a cross-sectional view showing a protrusion of a light shielding sheet engaging in a hole of a frame of a liquid crystal display device, according to a fifth embodiment of the present invention.

### DETAILED DESCRIPTION OF PREFERRED EMBODIMENTS

Reference will now be made to the drawings to describe the preferred embodiments in detail.

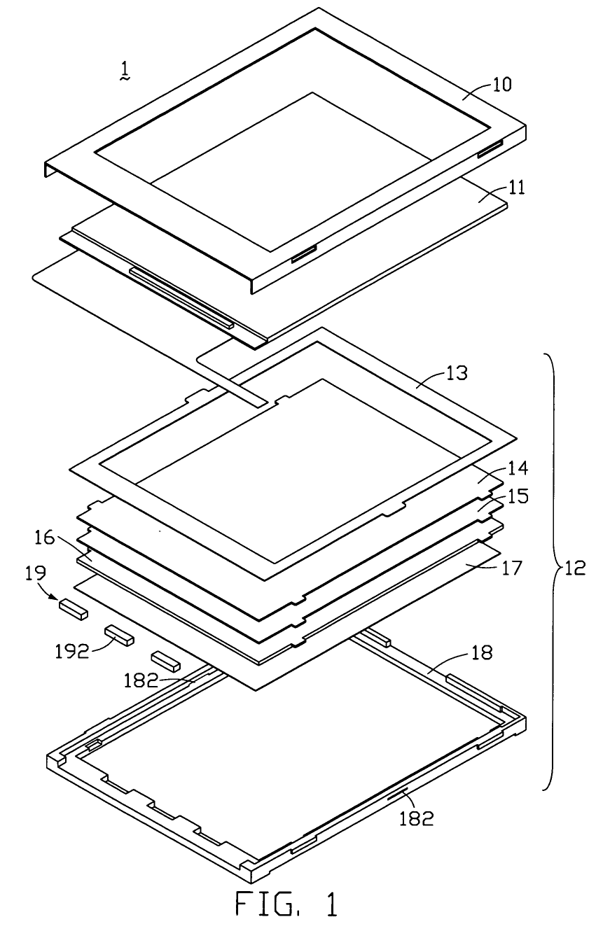

FIG. 1 is a schematic, isometric view of a liquid crystal display device according to a first embodiment of the present invention. The liquid crystal display device 1 includes a first frame 10, a liquid crystal panel 11, and a backlight module 12 in that order from top to bottom. The backlight module 12 includes a light shielding sheet 13, a prism sheet 14, a diffusing sheet 15, a light guide plate 16, a reflective sheet 17, and a second frame 18 in that order from top to bottom. The backlight module 12 further includes a light source 19 disposed adjacent to an end edge of the light guide plate 16. The liquid crystal panel 11 and the backlight module 12 can be accommodated in the first frame 10.

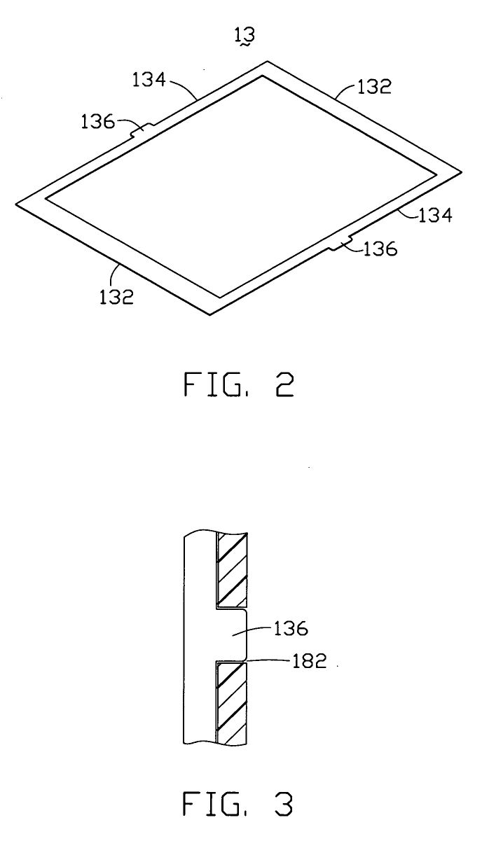

Referring to FIG. 2, the light shielding sheet 13 is a generally rectangular frame made of elastic material, and includes a pair of opposite outer walls 132 and another pair of opposite outer walls 134. Each outer wall 134 includes a rectangular protrusion 136 at a middle portion thereof. The protrusion 136 integrally extends coplanarly from the outer wall 134 in a direction away from a central long axis (not shown) of the light shielding sheet 13. The second frame 18 includes a pair of through holes 182 for receiving the protrusions 136 of the light shielding sheet 13. The light source 19 includes a plurality of aligned light emitting diodes (LEDs) 192. In an alternative embodiment, the light source 19 can be a cold cathode fluorescent lamp (CCFL).

Referring to FIG. 1 and FIG. 3, when the liquid crystal display device 1 is assembled, the liquid crystal panel 11 and the backlight module 12 are accommodated in the first frame 10. The prism sheet 14, the diffusing sheet 15, the light guide plate 16, and the reflective sheet 17 are disposed in the second frame 18 in that order from top to bottom. The light shielding sheet 13 is disposed between the liquid crystal panel 11 and the prism sheet 14. The light source 19 is disposed adjacent to the end edge of the light guide plate 16. The protrusions 136 of the light shielding sheet 13 are engagingly received in the through holes 182 of the second frame 18. Thus, the light shielding sheet 13 is firmly accommodated by the second frame 18, and covers edges of the prism sheet 14 and the second frame 18.

The light shielding sheet 13 is typically made of a polymer, such as polycarbonate (PC) or polyethylene terephthalate (PET). The first frame 10 is typically made of metal, and the second frame 18 is typically made of plastic.

The light shielding sheet 13 can prevent light beams of the backlight module 12 from leaking out of the backlight module 12 without the need for any adhesive. This means that any required disassembly of the liquid crystal display device 1 can be carried out conveniently, with little or no risk of damage occurring to the prism sheet 14 or the second frame 18. Furthermore, unlike in a conventional liquid crystal display device, because there is no adhesive used to secure the light shielding sheet 13, the so-called waving phenomena can be avoided. This helps ensure that the optical performance of the liquid crystal display device 1 is optimal.

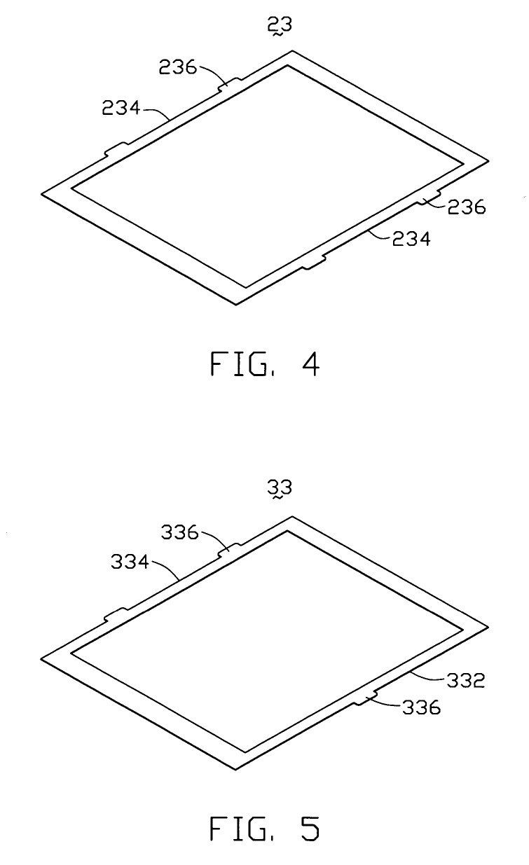

FIG. 4 is a schematic, isometric view of a light shielding sheet of a liquid crystal display device according to a second embodiment of the present invention. The light shielding sheet 23 is similar to the light shielding sheet 13. However, two opposite outer walls 234 of the light shielding sheet 23 each include two protrusions 236 integrally extending in a direction away from a central long axis (not shown) of the light shielding sheet 23. A frame (not shown) of the liquid crystal display device includes a plurality of holes (not shown), respectively corresponding to the protrusions 236 of the light shielding sheet 23.

FIG. 5 is a schematic, isometric view of a light shielding sheet of a liquid crystal display device according to a third embodiment of the present invention. The light shielding sheet 33 is similar to the light shielding sheet 13, except that the light shielding sheet 33 includes three protrusions 336. One outer wall 332 of the light shielding sheet 33 includes a protrusion 336 integrally extending therefrom, and another outer wall 334 opposite to the outer wall 332 includes two protrusions 336 integrally extending therefrom.

FIG. 6 is a schematic, isometric view of a light shielding sheet of a liquid crystal display device according to a fourth embodiment of the present invention. The light shielding sheet 43 is similar to the light shielding sheet 13. However, each of four outer walls 434 of the light shielding sheet 43 includes a protrusion 436 integrally extending therefrom.

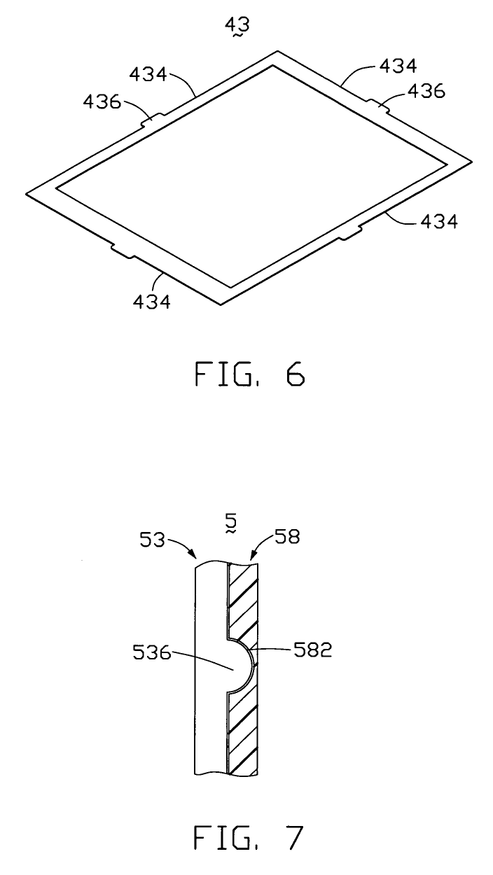

Referring to FIG. 7, a liquid crystal display device 5 according to a fifth embodiment of the present invention is similar to the liquid crystal display device 1. However, in the liquid crystal display device 5, each of protrusions 536 of a light shielding sheet 53 is hemicyclical. Each of holes 582 of a frame 58 of the liquid crystal display device 5 is a blind hemicyclical hole, the holes 582 corresponding to the protrusions 536. Thus the protrusions 536 of the light shielding sheet 53 can be conveniently inserted into and engaged in the holes 582 of the frame 58.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A frame-shaped light shielding sheet, comprising:
a plurality of outer walls; and
a plurality of protrusions formed on the outer walls, each of the protrusions extending in a direction away from a center of the light shielding sheet.

2. The light shielding sheet as claimed in claim 1, wherein the light shielding sheet is elastic.

3. The light shielding sheet as claimed in claim 1, wherein the light shielding sheet is generally rectangular.

4. The light shielding sheet as claimed in claim 3, wherein the protrusions are formed on two opposite of the outer walls.

5. The light shielding sheet as claimed in claim 3, wherein the protrusions are formed on all the outer walls.

6. The light shielding sheet as claimed in claim 1, wherein the protrusions are integrally formed with the outer walls.

7. The light shielding sheet as claimed in claim 1, wherein the protrusions are rectangular.

8. The light shielding sheet as claimed in claim 1, wherein the protrusions are hemicyclical.

9. A liquid crystal display device, comprising:
a liquid crystal panel; and
a backlight module disposed adjacent to the liquid crystal panel, comprising:
a first frame having a plurality of holes;
an optical sheet disposed in the first frame; and
an annular light shielding sheet disposed between the liquid crystal panel and the optical sheet, and comprising a plurality of outer walls;
wherein the outer walls comprise a plurality of protrusions, and each of the protrusions extends in a direction away from a center of the light shielding sheet.

10. The liquid crystal display device as claimed in claim 9, wherein the holes are through holes.

11. The liquid crystal display device as claimed in claim 9, wherein the holes are blind holes.

12. The liquid crystal display device as claimed in claim 9, wherein the light shielding sheet is generally rectangular.

13. The liquid crystal display device as claimed in claim 12, wherein the protrusions are formed on two opposite of the outer walls.

14. The liquid crystal display device as claimed in claim 12, wherein the protrusions are formed on all of the outer walls.

15. The liquid crystal display device as claimed in claim 1, wherein the protrusions are integrally formed with the outer walls.

16. The liquid crystal display device as claimed in claim 9, wherein the protrusions are rectangular.

17. The liquid crystal display device as claimed in claim 11, wherein the protrusions are hemicyclical.

18. The liquid crystal display device as claimed in claim 9, further comprising a second frame accommodating the liquid crystal panel and the backlight module.

19. A liquid crystal display device, comprising:
a liquid crystal panel; and
a backlight module disposed adjacent to the liquid crystal panel, comprising:
a bottom frame having a plurality of holes; and
an annular light shielding sheet enclosed in the bottom frame and comprising
a plurality of outer walls; wherein the outer walls comprise a plurality of protrusions, and each of the protrusions extends in a direction away from a center of the light shielding sheet and into the corresponding holes, respectively.
